(19) United States
(12) Patent Application Publication
(10) Pub. No.: US 2018/0307729 A1
(43) Pub. Date: Oct. 25, 2018

(54) METHOD AND APPARATUS FOR DETECTING A QUALITY WEATHER PROVIDER, WEATHER STATION, OR WEATHER REPORT

(71) Applicant: HERE Global B.V., Eindhoven (NL)

(72) Inventors: Alex AVERBUCH, Buffalo Grove, IL (US); Leon STENNETH, Chicago, IL (US)

(21) Appl. No.: 15/495,468

(22) Filed: Apr. 24, 2017

(51) Int. Cl. G06F 17/30; G01W 1/18

(52) U.S. Cl. CPC G06F 17/30477; G01W 1/18; G06F 17/30241

(57) ABSTRACT

An approach is provided for detecting a quality weather station, weather provider, or weather report. The approach involves retrieving a first set of weather data reported from a first set of weather stations of a first weather data provider. The approach also involves retrieving a second set of weather data reported from a second set of weather stations of a second weather data provider. The first set and second set of weather stations are located in a selected geographical area. The approach further involves interpolating the first set of weather data and the second set of weather data at common comparison locations. The approach further involves comparing the first and second interpolated weather data sets at the common comparison locations to determine an estimated quality of the first weather data provider and/or the second weather data provider.

### BACKGROUND

Real-time weather services historically have been one of the most popular information services among end users. This has led to a significant increase in the number of weather service providers (e.g., governmental providers, commercial providers, crowd-sourced providers, etc.), with each providing varying levels quality (e.g., in terms of accuracy, specificity, etc.). At the same time, precise weather estimation has become important in new areas, such as autonomous driving, where weather data can be used to make critical vehicle operation decisions. Accordingly, service providers face significant technical challenges to enabling automated characterization of the quality of a given weather provider, weather station used by the provider, and/or even an individual weather report delivered by the provider, particularly as the number of providers, stations, and/or reports increase.

### SOME EXAMPLE EMBODIMENTS

Therefore, there is a need for an automated approach to detecting a weather provider, weather station, and/or weather report that, for instance, meet predetermined quality criteria.

According to one embodiment, a computer-implemented method comprises retrieving a first set of weather data reported from a first set of weather stations of a first weather data provider. The first set of weather stations is located in a selected geographical area. The method also comprises retrieving a second set of weather data reported from a second set of weather stations of a second weather data provider. The second set of weather stations is also located in the selected geographical area. The method further comprises interpolating the first set of weather data to determine a first interpolated weather data set at one or more common comparison locations. The method further comprises interpolating the second set of the weather data to determine a second interpolated weather data set at the one or more common comparison locations. The method further comprises comparing the first interpolated weather data set and the second interpolated weather data set at the one or more common comparison locations to determine an estimated quality of the first weather data provider, the second weather data provider, or combination thereof.

According to another embodiment, an apparatus comprises at least one processor, and at least one memory including computer program code for one or more computer programs, the at least one memory and the computer program code configured to, with the at least one processor, cause, at least in part, the apparatus to retrieve a first set of weather data reported from a first set of weather stations of a first weather data provider. The first set of weather stations is located in a selected geographical area. The apparatus is also caused to retrieve a second set of weather data reported from a second set of weather stations of a second weather data provider. The second set of weather stations is also located in the selected geographical area. The apparatus is further caused to interpolate the first set of weather data to determine a first interpolated weather data set at one or more common comparison locations. The apparatus is further caused to interpolate the second set of the weather data to determine a second interpolated weather data set at the one or more common comparison locations. The apparatus is further caused to compare the first interpolated weather data set and the second interpolated weather data set at the one or more common comparison locations to determine an estimated quality of the first weather data provider, the second weather data provider, or combination thereof.

According to another embodiment, a computer-readable storage medium carries one or more sequences of one or more instructions which, when executed by one or more processors, cause, at least in part, an apparatus to retrieve a first set of weather data reported from a first set of weather stations of a first weather data provider. The first set of weather stations is located in a selected geographical area. The apparatus is also caused to retrieve a second set of weather data reported from a second set of weather stations of a second weather data provider. The second set of weather stations is also located in the selected geographical area. The apparatus is further caused to interpolate the first set of weather data to determine a first interpolated weather data set at one or more common comparison locations. The apparatus is further caused to interpolate the second set of the weather data to determine a second interpolated weather data set at the one or more common comparison locations. The apparatus is further caused to compare the first interpolated weather data set and the second interpolated weather data set at the one or more common comparison locations to determine an estimated quality of the first weather data provider, the second weather data provider, or combination thereof.

According to another embodiment, an apparatus comprises means for retrieving a first set of weather data reported from a first set of weather stations of a first weather data provider. The first set of weather stations is located in a selected geographical area. The apparatus also comprises means for retrieving a second set of weather data reported from a second set of weather stations of a second weather data provider. The second set of weather stations is also located in the selected geographical area. The apparatus further comprises means for interpolating the first set of weather data to determine a first interpolated weather data set at one or more common comparison locations. The apparatus further comprises means for interpolating the second set of the weather data to determine a second interpolated weather data set at the one or more common comparison locations. The apparatus further comprises means for comparing the first interpolated weather data set and the second interpolated weather data set at the one or more common comparison locations to determine an estimated quality of the first weather data provider, the second weather data provider, or combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of calculating a quality level of a weather provider, weather station, or weather report, according to one embodiment;

FIGS. 2A and 2B are diagrams illustrating an example process for interpolating weather data to calculate a quality of level of weather providers, according to one embodiment;

FIGS. 3A and 3B are diagrams illustrating an example process for detecting an erroneous weather station from historical and instantaneous weather data, according to one embodiment;

FIG. 4 is a diagram illustrating an example process for suppressing weather report records for mobile weather stations, according to one embodiment;

FIG. 5 is a diagram of a geographic database, according to one embodiment;

FIG. 6 is a diagram of the components of a weather quality platform, according to one embodiment;

FIG. 7 is a flowchart of a process for determining an erroneous weather provider, according to one embodiment;

FIGS. 8A and 8B are a flowchart of a process for determining an erroneous weather station, according to one embodiment;

FIG. 9 is a flowchart of a process for determining an erroneous weather report, according to one embodiment;

FIG. 10 is a diagram illustrating an example user interface for detecting an erroneous weather station, according to one embodiment;

FIG. 11 is a diagram of hardware that can be used to implement an embodiment;

FIG. 12 is a diagram of a chip set that can be used to implement an embodiment; and

FIG. 13 is a diagram of a mobile terminal (e.g., handset) that can be used to implement an embodiment.

### DESCRIPTION OF SOME EMBODIMENTS

Examples of a method, apparatus, and computer program for detecting a quality weather provider, weather station, or weather report are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

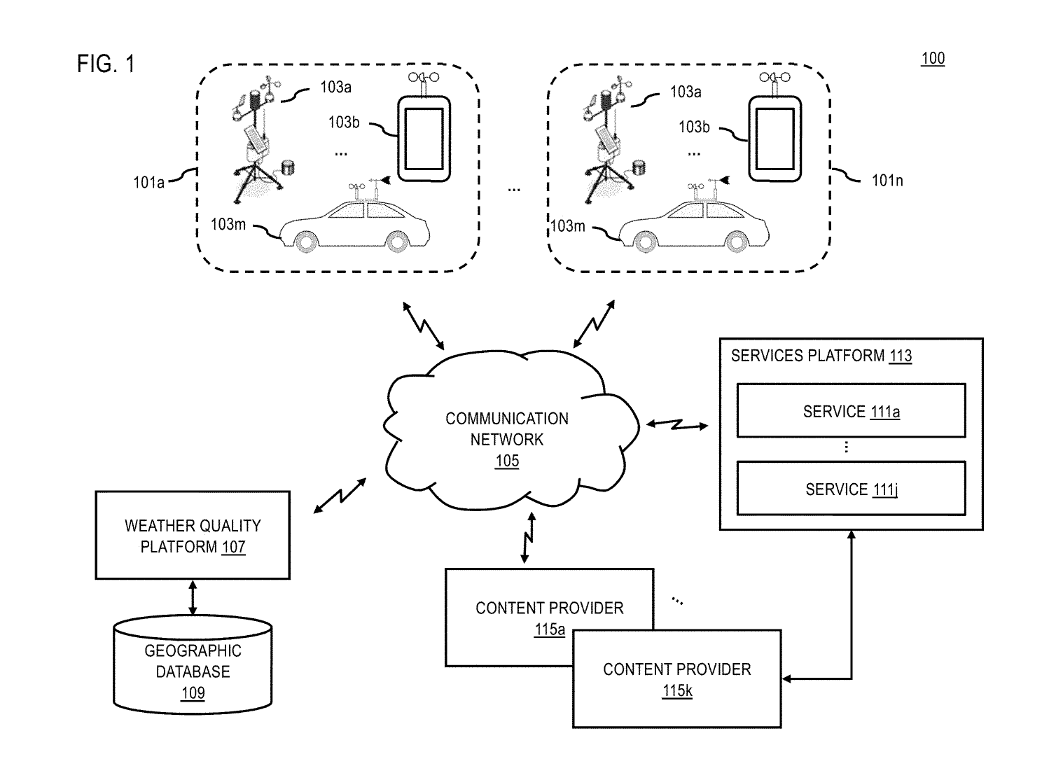

FIG. 1 is a diagram of a system capable of calculating a quality level of a weather provider, weather station, or weather report, according to one embodiment. As noted above, the growing popularity and use of weather data have led to a corresponding increase in the number of weather service or weather data providers to meet the demand for weather data (e.g., current weather condition reports for attributes such as temperature, wind speed, precipitation type, amount of precipitation, atmospheric pressure, ambient light, etc.). However, these increasing numbers of weather service providers may have different weather collection methodologies, different locations for their weather stations, different types of weather stations, different types of weather sensors, etc. that can potentially affect the quality (e.g., accuracy, consistency, etc.) of the reported weather data.

Furthermore, as the number of weather providers increases, the number of weather stations each provider operates and the amount of weather data (e.g., the weather data reports or data records) the weather stations generate also increase. As a result, there are significant technical challenges associated with providing automated means for collecting, processing, and analyzing such high volumes of weather data to calculate a quality of level at different levels of granularity of the weather reporting system. By way of example, estimating quality at different levels of granularity ranges from estimating a quality of individual weather providers, to estimating a quality of individual weather stations operated by the providers, and further to estimating a quality of the individual weather data records or reports generated by each weather station. In one embodiment,

For example, with respect to weather service providers, the diversity of providers can be a challenge. In one embodiment, as shown, a system 100 of FIG. 1 may include one or more weather service providers 101a-101n (also collectively referred to as weather service providers 101). Each of the weather service providers 101 can operate a respective set of weather stations 103a-103m (also collectively referred to as weather stations 103) dispersed over a geographical area of coverage. The weather stations 103 include any combination of fixed weather stations (e.g., anchored to a fixed geographic location for provide weather data for that fixed location) and mobile weather stations (e.g., able to travel within a geographical area to collect weather data at different locations). Mobile weather stations can further include both portable devices equipment weather data sensors as well as mobile weather stations mounted or fixed to vehicles (e.g., cars) which can then travel within a geographical area to collect weather data. Because of this diversity of providers weather service providers 101, different weather service providers 101 can potentially provide totally different weather reports (e.g., different temperatures) for the same point on earth, thereby indicating that at least one of the weather service providers 101 can be providing potentially erroneous weather data. This can be due, for instance, to incorrectly calibrated weather stations 103 for a given weather service provider 101.

As discussed, weather service providers 101 can vary based on the types of weather stations and/or the locations of the weather stations. For example, there are global weather data providers 101 (e.g., the U.S. National Oceanic and Atmospheric Administration (NOAA), Custom Weather, Iteris, etc.) that use fixed weather stations to provide an estimation of weather for any inputted location. Municipals/states/provinces (e.g., such as the Colorado Department of Transportation (CDOT)) can also have their own personal sets of weather stations 103.

Furthermore, automobile original equipment manufacturers (OEMs) (e.g., BMW, Audi, and Daimler) may have connected cars (e.g., cars with communication capabilities over a communication network 105) that can sense and report the weather condition or data. Thus, OEMs can also become weather service providers 101 by using their cars as mobile weather stations 103. However, the use of cars as mobile weather stations can sometimes introduce systematic errors into the data generated by an OEM weather service provider 101. For example, one issue with OEM vehicles can be that their temperature sensor are usually located too close to the engine, hence the reported air temperature is always higher than ground truth.

Further, other companies or weather service providers 101 (e.g., WeatherUnderground) may crowdsource weather data from light-weight and inexpensive weather stations 103 that are owned by the public. These weather stations 103 tend to be more cheaply made and less reliable than used by the other providers 101 discussed above. Therefore, the quality (e.g., accuracy, consistency, etc.) of the weather data may not be as high as the other weather service providers 101, and may not be appropriate for uses where precise weather information may be needed (e.g., autonomous driver). In addition, data from crowdsourced weather stations 103 can also be erroneous since some owners tend to have the weather station 103 inside their house in winter. This can lead to reporting very warm temperatures which can be misleading.

Accordingly, with so many different weather service providers 101 that are on the market, a solution that automatically identifies an erroneous weather provider is needed. In addition to identifying an erroneous weather service provider 101, there is also the problem of how to identify an erroneous weather station operated by weather service provider 101 that might otherwise provide non-erroneous weather data. For example, just one or a few weather stations 103 operated by a weather service provider 101 can potentially result in the weather service provider 101 as a whole being classified as erroneous. Therefore, a solution that automatically identifies erroneous weather stations 103 is also needed.

As noted above, there are two main types of weather stations 103 that can be used by weather service providers 101: (1) stationary or fixed weather stations, and (2) mobile weather stations. By way of example, stationary weather stations 103 are normally installed at locations (e.g., airports, army bases, public buildings, etc.) that are strategically selected so that their observations of the atmospheric condition and other weather data is realistic. However, this carefully selected location is often not the case with respect to mobile weather stations 103. For. These mobile weather stations 103 include vehicles, mobile phones, wearables, and/or other portable devices that all have weather sensors and provide weather reports which, for instance, are aggregated with other reports to provide an estimation of weather. In many cases, these mobile weather stations 103 are owned by the public, and they are not guaranteed to be in a good location when they provide weather reports. For example, a vehicle could be under a tunnel when it provides a weather report. For another example, a human could be in their hot basement with their mobile phone when it provides a weather report. Accordingly, another problem is that there is a need to select high quality weather reports from mobile weather stations 103 since their locations at the time of their weather reports may not be ideal because they are always moving.

In summary, the problems associated with detecting a quality weather provider 101 relates, in part, to how to compare different weather service providers 101 to detect an erroneous provider 101 given the diversity of weather station locations between providers 101. The problems associated with detecting a quality weather station relates to how to identify in real-time when a weather station is erroneous or faulty, resulting in poor quality weather data. Finally, the problems associated with detecting a quality weather report from mobile weather stations 103 relate to how to ensure that poor quality locations of the mobile weather stations 103 do not result in poor quality weather data.

To address the problems, the system 100 of FIG. 1 introduces the capability to detect an erroneous weather provider by interpolating the weather service provider 101 to common comparison locations to compare against ground truth weather data or weather data from another weather service provider 101 that have also been interpolated to the same common comparison locations. In one embodiment, the system 100 also introduces a capability to detect an erroneous weather station by historical and instantaneous comparison of weather data collected from the weather station. In yet another embodiment, the system 100 further introduces a capability to detect an erroneous weather report from a mobile weather station 103 by map matching a location of the mobile weather station 103 determined when the mobile weather station 103 makes a weather report. The embodiments of the system 100 described herein, for instance, advantageously enable automated detection of potentially erroneous weather station hardware to improve weather data quality. Additional details of these embodiments of the system 100 are discussed below.

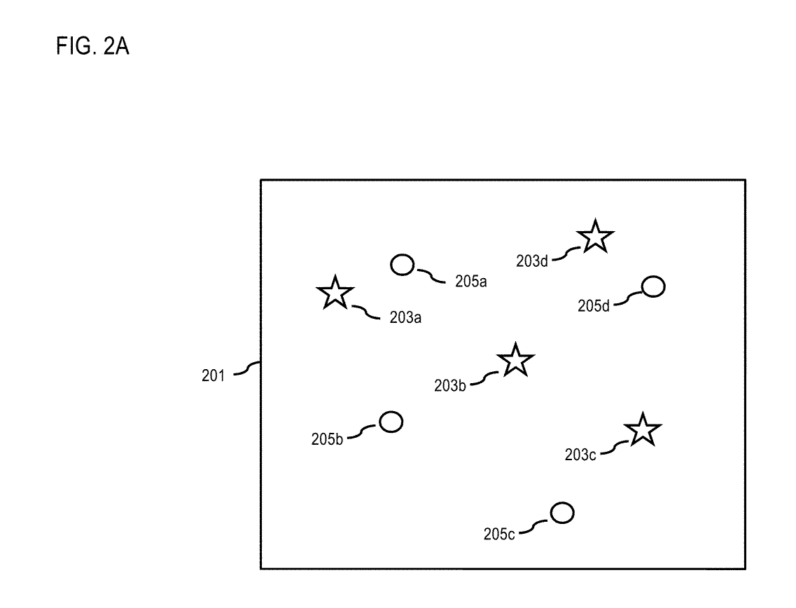

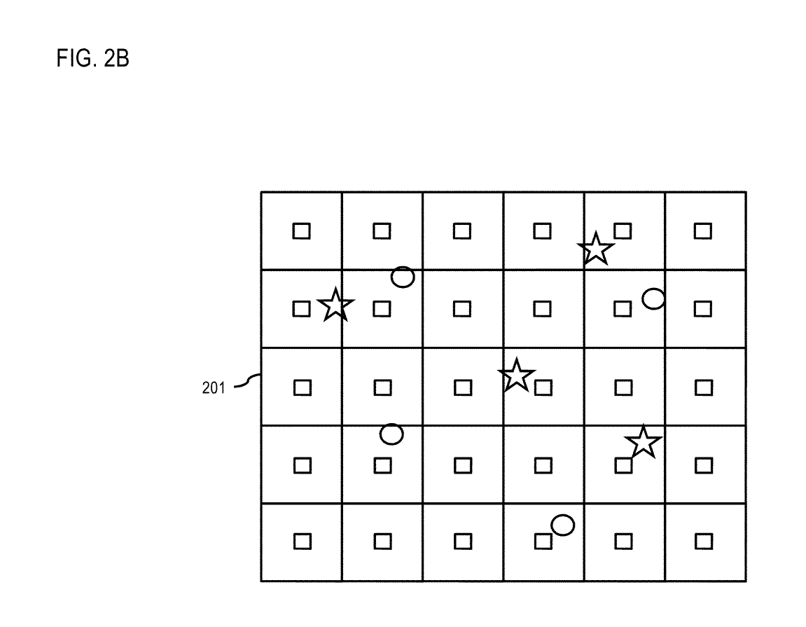

FIGS. 2A and 2B are diagrams illustrating an example process for interpolating weather data to calculate a quality of level of weather providers, according to one embodiment. The invented scheme to identify erroneous weather providers is as follows. In one embodiment, the system 100 initiates the process of estimating a quality level of a weather service provider 101 to identify erroneous providers 101 by first selecting (e.g., via a weather quality platform 107) a region where several weather providers 101 have multiple weather stations 103. FIG. 2A illustrates an example geographical region 201 in which is a first weather service provider 101a operates a first set of weather stations 203a-203d (also collectively referred to as weather stations 203) indicated by star symbols, and a second weather service provider 101b operates a second set of weather stations 205a-205d (also collectively referred to as weather stations 205) indicated by circle symbols. In this example, the different providers 101a and 101b have weather stations at different physical locations. Hence, comparing providers 101a and 101b against each other is difficult since a station by station comparison for each provider 101a and 101b may not yield acceptable results because the stations 203 and 205 are at different locations.

In one embodiment, the weather quality platform 107 can further select the weather stations 203 or 205 that are to represent each provider 101a or 101b based on additional selection criteria. For example, the additional selection criteria can include a distance threshold (e.g., less than 1 km) so that only nearby weather stations 203 and 205 are selected. In another embodiment, the selection criteria can be based proximity to any map features that can potentially affect weather data. For example, the weather quality platform 107 can query a geographic database 109 to determine whether there is terrain with high elevation (e.g., hills, mountains, etc.) between any of the weather stations 203 and 205. The weather quality platform 107 can then select only those weather stations 203 and 205 where there are no such features (e.g., where there are no hills or mountains between any stations 203 and 205 that are to be directly compared).

In one embodiment, after selecting the representative geographical region and/or weather stations 203 or 205, the system 100 (e.g., via weather quality platform 107) can select a ground truth weather provider for detecting erroneous weather service providers 101. This ground truth weather provider is typically a trusted source that that system 100 can use as a bench mark. In one embodiment, the ground truth weather provider can be selected from among the one or more service provider's represented in the selected region (e.g., weather service provider 101a or 101b). In addition to selecting the ground truth weather provider, the system 100 can also select one or more weather attributes that are to be tested to estimate a quality of the weather service providers 101a or 101b. Weather attributes are any weather parameter that is sensed or determined by the weather station including, but not limited to, air temperature, wind speed, precipitation, barometric or atmospheric pressure, etc. It is contemplated that quality assessments (e.g., whether a provider 101 is erroneous) can be made with respect to individual parameters. In this way, the system 100 may find one provider 101 that is erroneous with respect to one attribute (e.g., air temperature), but not erroneous with respect to another (e.g., barometric pressure). In one embodiment, it is contemplated that the quality assessment can be based on an aggregate of multiple attributes (e.g., both air temperature and pressure in combination).

As shown in FIG. 2B, the quality assessment further includes generating regular grid location points within the region 201. For example, FIG. 2B shows the region 201 overlaid with a grid to create multiple grid cells. A grid location point in each grid cell is indicated by a square symbol. As with FIG. 2A, the star symbols (not labeled in FIG. 2B for clarity of the figure drawing) represent the weather stations 203 of the first weather provider 101a and the circle symbols (also not labeled for clarity of the figure drawing) represent the weather stations 205 of the second weather provider 101b. In one embodiment, the number of grid cells (e.g., how fine the grid is) is determined so that it minimizes or avoids biasing the spatial distribution of the grid location points.

In one embodiment, the system 100 uses the each of the grid location points as common locations against which the weather service providers 101a and 101b and/or the ground truth weather provider are compared to make a quality level assessment of the weather data collected from the providers. For example, both providers 101a and 101b will provide an interpolated estimation of the selected weather attribute (e.g. air temperature) for the location of each grid point (e.g., the common comparison locations). The estimation is interpolated because station locations are not necessarily the same as the grid locations. Accordingly, either the weather service providers 101a and 101b themselves or the system 100 can interpolate weather data for a given grid location point or comparison point from the weather data collected at the locations of the respective weather stations 203 and 205. In other words, for each grid point or comparison point (e.g., indicated by the square symbols in FIG. 2B) in the region 201 and for each data provider 101a and 101b, the system 100 will have an estimation of weather. Likewise, for the ground truth weather provider if one is selected.

More specifically, in one embodiment, the weather quality platform 107 selects each grid point or common comparison point (e.g., each location indicated by the square symbol in FIG. 2B) and applies any known weather estimation algorithm to estimate respective values for the selected weather attributes at the common comparison (e.g., grid location points) for each provider of interest 101a and 101b, and also the ground truth provider if applicable. As a result, each grid location point or common comparison point shown in FIG. 2B would have at least two estimations or interpolated weather attribute values: one interpolated weather attribute value for weather service provider 101a and another interpolated weather attribute value for weather service provider 101b. If one of the service providers 101a or 101b is selected as the ground truth provider, then the interpolated attribute value corresponding to the selected provider 101a or 101b would represent the ground truth against which the other attribute value is compared. If a ground truth provider other than service provider 101a or 101b is used, then each location point can have three interpolated values (e.g., two for each provider 101a and 101b, and one for the ground truth provider).

In one embodiment, the interpolation of the weather data enables the system 100 to more accurately compare the weather data sets because the interpolated values are now referenced to same common comparison locations. In this way, the system 100 advantageously avoids having to compare weather data corresponding to different locations because two different weather providers 101a and 101b would rarely have weather stations 203 and 205 located at the exact same location to allow for direct comparison. Because of the highly variable nature of weather data, even slight differences in location can result in large disparities between values, thereby making direct comparisons between weather data taken from different locations less accurate or reliable.

After interpolating the weather data sets, the system 100 can compare the interpolated data sets at each common comparison location. For example, now that each grid location point or common comparison point has at least two estimations or interpolated values (e.g., each corresponding to the weather service providers 101a or 101b, or the ground truth weather provider). In one embodiment, a computed difference of 0 indicates that both sets of weather stations 203 and 205 are agreeing, and none is erroneous. A difference greater than zero indicates increasing probability that at least one of the providers is erroneous, or if there is a ground truth weather provider, indicates that the non-ground-truth weather provider is potentially erroneous.

In one embodiment, the system 100 can compute an average difference from each of the common comparison points in the selected region (e.g., each grid location point of the grid applied to the selected region). If the average difference across the grid or common comparison points is greater than a predetermined threshold, then system 100 can designate the weather provider 101a or 101b associated with the high average difference as erroneous. In one embodiment, the system 100 can then indicate that the weather data for the erroneous weather provider 101a or 101b should be used with less confidence, its data should be suppressed from the system, or used for when precise weather data is not needed (e.g., tasks not related to autonomous driving). In one embodiment, different weather attributes can have different thresholds. For example, the thresholds for air temperature difference and pressure difference can be calculated independently and may not necessarily be the same.

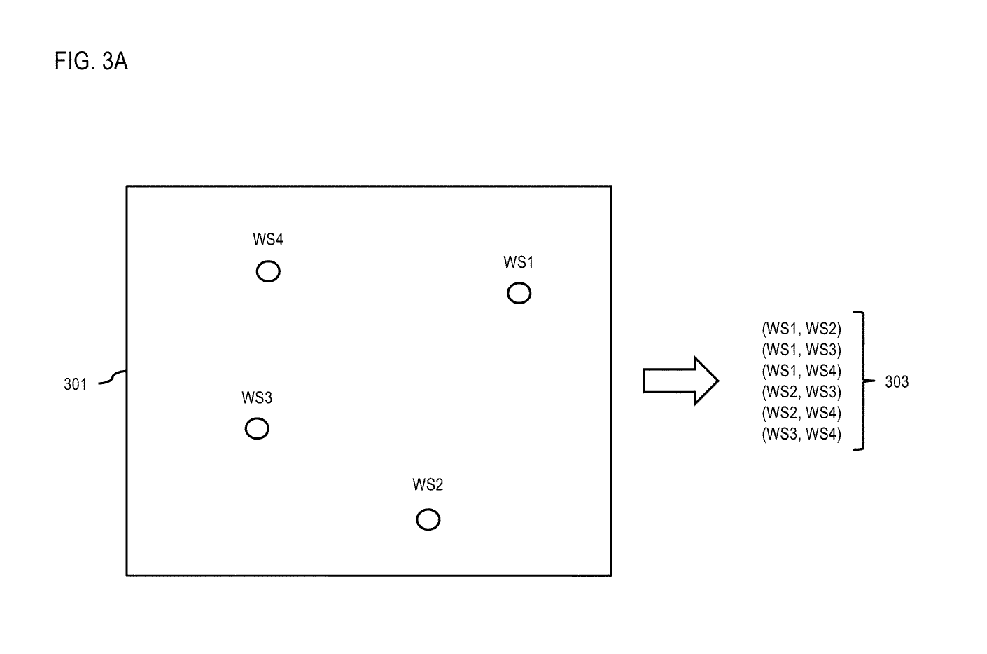

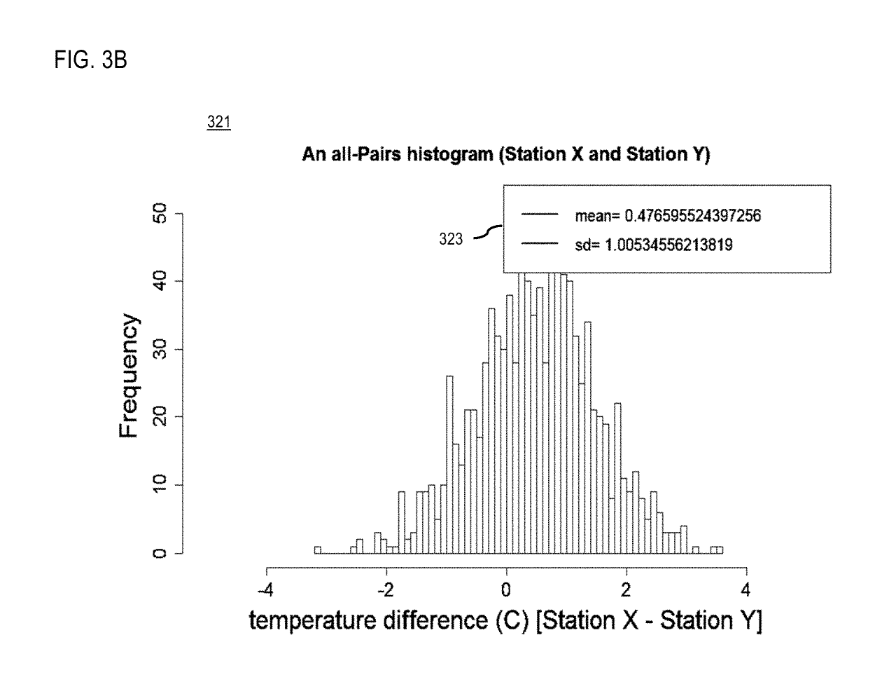

FIGS. 3A and 3B are diagrams illustrating an example process for detecting an erroneous weather station from historical and instantaneous weather data, according to one embodiment. In many cases, weather stations are located a different locations around the world. However, weather stations that are very close in distance (e.g., few meters or other distance threshold) should report almost the same weather condition. In one embodiment, the system 100 can use this assumption to detect potentially erroneous weather stations. In response to a detection, the system 100, for instance, can initiate remedial action to address the potentially erroneous weather station (e.g., suppress data from the weather station, initiate maintenance/repair of the weather station, deactivate the station, etc.).

In one embodiment, to detect a potentially erroneous weather station in real-time, the weather quality platform 107 projects a search radius around a given weather station or otherwise designates a geographical region or area in which to detect erroneous weather stations. For example, the size of the search radius or selected geographical area can be approximately a few kilometers (e.g., 1 to 5 km). In one embodiment, the search radius or geographical area is minimized to increase a likelihood that any two stations within the search radius or area will be close enough in distance to have similar weather. With a larger radius, it becomes more likely that the weather at any two stations can be different, which can make the process for detecting erroneous stations potentially less reliable. However, if distance is not a concern, any search radius or area can be used.

In one embodiment, the weather quality platform 107 can also select the weather parameter or attribute that is to be evaluated (e.g., air temperature). In one embodiment, the weather quality platform 107 selects a specific weather attribute to evaluate for error because a weather station may report some attributes correctly and other incorrectly at the same time. Each weather station have several sensors for sensing any number of weather attributes or parameter including, but not limited to: temperature, pressure, humidity, precipitation intensity, etc. Any one of these sensors could be erroneous while the others work perfectly. In other words, a given weather station could report some attributes precisely and others erroneously.

In one embodiment, after identifying the weather stations falling within the selected search radius or area of interest, the weather quality platform 107 constructs an all-pairs historical difference distribution (e.g., a histogram of historical differences in weather values) for all stations in the search radius or area. For example, FIG. 3A illustrates an example geographical region 301 that has been selected in which to detect potentially erroneous weather stations. In this example, the region 301 encompasses four weather stations labeled WS1, WS2, WS3, and WS4. FIG. 3A also depicts the all-pairs list 303 for the region 301. In one embodiment, all-pairs list includes all possible unique pairs of the weather stations WS1-WS4. Observe that, in this embodiment, a station and itself cannot be in the all-pairs list, thus pairs such as (WS1, WS1) is not used. Also, in this embodiment, the pair (WS1, WS2) is the same as (WS2, WS1) and only one of the two is included in the all-pairs list 303. It is contemplated that anyone of the two possible combination can be included in the all-pairs list 303. Thus, for each of the resulting six pairs of weather stations in the all-pairs list 303, the system 100 can build a histogram of the difference in weather station value for the selected weather attribute. In one embodiment, the weather quality platform 107 constructs these histograms using historical weather data for the identified weather stations (e.g., weather stations WS1-WS4). In one embodiment, the historical data go back any predetermined amount of time (e.g., X years where X is calibrated to ensure a representative historical sample). For example, in one embodiment, X can be set to at least 1 to cover the entire year and capture any seasonal effects on possible differences between any two weather stations.

FIG. 3B illustrates an example of such a histogram 321. From the single all-pair histogram 321 shown in FIG. 3B, the following observations are apparent: (1) the air temperature reported by station X is slightly warmer than station Y; and (2) generally, the historical temperature difference between station X and station Y is no more than 4° C. In one embodiment, the weather quality platform 107 does not store the entire histogram. Instead, the weather quality platform 107 extracts and stores the mean and standard deviation of the histogram indicated in the legend box 323. In one embodiment, the weather quality platform 107 compiles all of the mean differences and standard deviations from the mean difference for each pair of weather stations. The mean and standard deviation values are stored in a table as shown in Table 1 below. In one embodiment, the table is indexed by the station pair identifier.

TABLE 1

| Station Pair | Mean | Standard deviation |
|---|---|---|
| XY | 0.46 | 1.005 |
| . . . | . . . | . . . |

After creating the histograms and/or mean/standard table, the weather quality platform 107 can beginning real-time monitoring of weather stations to detect any erroneous stations. For example, the weather quality platform 107 computes the difference in reported values for selected weather attributes in real time as the weather reports are received for each pair of weather stations. In one embodiment, this real-time difference is referred to as the “instantaneous difference” as opposed to the mean difference computed above which is referred to as the “historical difference.” The weather quality platform 107 extract the historical difference and standard deviation of the difference for each pair of weather stations for real-time comparison. In one embodiment, the historical mean difference and standard deviation can be extracted from Table 1 or equivalent for to perform the real-time comparison.

In one embodiment, if the instantaneous difference computed above exceeds the historical standard deviation for the historical mean difference by a predetermined threshold factor (e.g., 3 times the standard deviation), the weather quality platform 107 can determine that this is an indication that at least one of the weather stations in the pair reported some erroneous value. For example, using the pair of stations in Table 1, if in real time the instantaneous difference is 2° C. for stations X and Y, then it indicates normal behavior and none of the stations are erroneous. For another example, if the instantaneous difference is greater than 4.5° C., then it is indicative that weather station X and/or Y is erroneous. In one embodiment, greater differences indicates a greater likelihood of erroneous behavior.

In one embodiment, to determine the specific weather station in pair that reported the erroneous value, the weather quality platform 107 aggregates all the pairs of station that have meet the criteria for indicating an erroneous weather station according to embodiments described above (e.g., real time or instantaneous difference is greater that the historical standard deviation from the historical mean by more than a predetermined factor), then the stations with the highest votes or occurrence in the aggregated pairs (e.g., greater than 1 occurrence) are the erroneous weather stations. In other words, when the instantaneous difference is more than Z standard deviations from the historical mean where Z is a calibrated real number with an example value of 3, the weather quality platform 107 can determine there is an indication that at least one of the weather stations in the pair is erroneous or faulty. Then after analyzing the set of possible erroneous pairs of stations, the stations that occurs more frequently (e.g., voting) in the sets are erroneous.

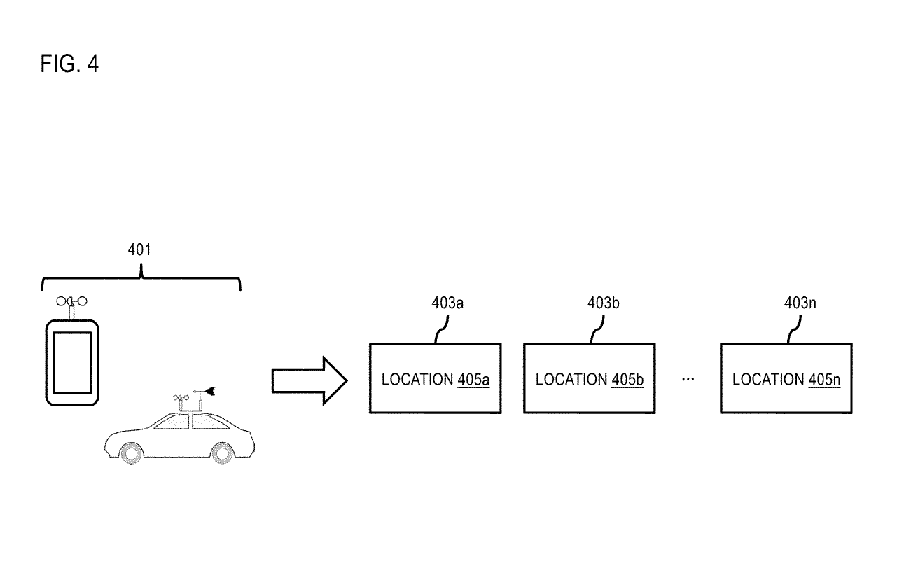

In one embodiment, the system 100 also includes processes for determining quality weather reports, and in particular, quality weather reports originating from mobile weather stations. FIG. 4 is a diagram illustrating an example process for suppressing weather report records for mobile weather stations, according to one embodiment. A capability to determine quality weather reports from mobile weather stations is particularly advantageous because when a mobile weather station provides an estimation of weather, the mobile weather station may not be at a location on the map that can provide representative weather data. As shown, one or more mobile weather stations 401 (e.g., portable weather stations, mobile phone based weather stations, connected cars with weather sensors, etc.) are capable of traveling with a road network of a map (e.g., a map represented in the geographic database 109) as they generate weather data records 403a-403n (also collectively referred to as weather data records 403). Each of the weather data records 403a-403c can be respectively sensed at different locations 405a-405c (also collectively referred to as locations 405) because the weather stations 401 are mobile. Since the location of mobile weather stations 401 can change all the time, the system 100 (e.g., via the weather quality platform 107) can check where on the map a mobile weather station 401 is before using its data. Based on the checked location of the mobile weather stations 401, the weather quality platform 107 can determine whether to suppress or use a corresponding weather data record 403.

In one embodiment, the quality weather platform 107 can suppress weather reports based on map match probability of the mobile weather station 401. For example, for all mobile weather stations 401, before using their weather data, their locations are first map matched to the road network (e.g., of the geographic database 109) to see if the mobile weather station 401 is on any road of the network. In one embodiment, the weather quality platform 107 does not use reports from mobile weather stations 401 that are not on a road. For example, a mobile phone that is acting as a weather station and is located in a user's living room should not be used because it is likely to give a poor quality indoor weather reading that would not be representative of actual weather outside of the user's home. Similarly, a connected and weather sensor-equipped vehicle parked in a garage should also not be used as a mobile weather station 401 for the same reason.

Thus, in one embodiment, each mobile weather station 401 reports its location and timestamp along with its weather observation. The weather quality platform 107 can then use the reported location (e.g., a location 405) for map matching. For example, the map matching procedure take as input the weather station location 405 and a map with the road network (e.g., the geographic database 109) and outputs a matching probability which reflects the certainty that the mobile weather station 401 is on a road. In one embodiment, the map matching probability is used to accept or reject the weather report from the mobile weather station 401. In one embodiment, the weather quality platform 107 defines two map matching probability thresholds. One threshold is for the case when map matching is performed using a location and heading (e.g., a high speed case), and the other is for the case where map matching is done using solely a location (e.g., a low speed case). If the map matching probability for a mobile weather station 401 with respect to the surrounding road links goes below these thresholds, then the weather report is suppressed as low quality because the mobile weather station is designated as not being on the road network. If the mobile weather station is on the road network, then the matching probability would likely be high.

In one embodiment, the weather quality platform 107 can suppress weather reports based on the transportation mode of the mobile weather station 401. For example, the transportation mode can be the mode used by a person or other object carrying the mobile weather station 401 (e.g., mobile phones, wearables, etc.). In one embodiment, transportation mode detection identifies a traveler's mode of transportation such as: car, bus, aboveground train, walking, bike, and stationary from sensor data (e.g. GPS). In some of these cases, the transportation mode indicates a likelihood that the mobile weather station 401 is located inside a vehicle. For example, if the transportation mode is a car and the mobile weather station 401 is carried by a user in the car, it is also likely that the mobile weather station 401 would be inside the car. In this case, being inside a car or other motorized vehicle can potentially result in a generating weather reports or data (e.g., air temperature) that are not representative of the actual outside weather condition, thereby resulting in a poor quality weather report. Conversely, transportations modes that indicate a user is likely to be outdoors and can provide outside weather data can be used. These transportation modes include, but are not limited to, pedestrian modes, bicycling, etc. in which travelers are not likely to be inside of a vehicle. It is contemplated that any means known in the art for detecting transportation mode can be used with the embodiments described herein. In other words, in one embodiment, weather reports that are coming from mobile weather stations 401 that are mobile phones or other similar devices that are inside of cars, trucks, trains, and buses are not used because the weather data (e.g. temperature) that is provided are for the inside of vehicles. Thus, the weather quality platform 107 can use a transportation mode detection algorithm to determine the mode of transportation of the mobile weather station 401 (e.g., mobile phone or wearable). Then, if the transportation mode is identified as been motorized or otherwise indicate that the mobile weather station 401 would be carried inside a vehicle, the weather reports are suppressed. Otherwise, if the transportation mode is identified as being a bike, walk/run, or other transportation mode that indicates that the mobile weather station 401 would be exposed to the outside ambient environment, then the weather report is used.

In one embodiment, the weather quality platform 107 can suppress weather reports based on if the reporting mobile weather station 401 is on a road that may have a map feature that could affect weather data (e.g., a road with a tunnel, or other feature that could isolate or cover the mobile weather station from the environment). For example, as described previously with respect to the map matching embodiment above, for all mobile weather stations 401, the weather quality platform 107 map matches their locations to a road network (e.g., represented in the geographic database 109) to see if the mobile weather station is on the road with such as map feature (e.g., a tunnel, covered highway, etc.) before using or suppressing its weather data. For example, if a mobile weather station 401 is travelling under a tunnel, the weather quality platform 107 suppresses the corresponding weather data or report.

More specifically, to determine if a weather report came from a mobile weather station 401 that is traveling on road with feature that can potentially result in reporting weather data that does not reflect outside ambient weather conditions (e.g., under a tunnel), the weather quality platform 107 the procedure is as follows: (1) map match the mobile weather station's location to the road network; (2) determine the link ID of the road link that the station is matched to; (3) use the link ID to query a map database of link attributes (e.g., the geographic database 109) to see if there is a tunnel or other map feature that could isolate or cover the mobile weather station 401 from the outside environment on the link; and (4) if a tunnel or other feature is on the link, reject or suppress the weather report coming from the mobile weather station, for instance, by not using the suppressed weather report or data for weather estimation outside of the tunnel or map feature.

In one embodiment, the weather quality platform 107 can suppress weather reports based on a mobile weather station to mobile weather station comparison or check. For example, the weather quality platform 107 can suppress weather reports originating from mobile weather stations 401 whenever the platform 107 detects that two or more mobile weather stations 401 come within close proximity to each other (e.g., within a predetermined distance threshold, such as 3 km) and their weather reports collected at approximately the same time are significantly different (e.g., differs beyond a threshold difference). In this embodiment, the weather quality platform 107 can suppress weather reports from both the two or more mobile weather stations 401 from the system. This is because, the weather quality platform 107 is configured to assume no ground truth data, and instead, to assume that differences beyond a threshold difference can indicate potential problems among all of the two or more mobile weather stations 401 being compared.

In another embodiment, the weather quality platform 107 can suppress weather reports based on a mobile weather station 401 to fixed weather station comparison. For example, the weather quality platform 107 can suppress weather reports from a mobile weather station 103 whenever the mobile weather station 401 comes within close proximity to a trusted fixed weather station (e.g., a government owned weather station, or weather station from a previously trusted organization) such as those at airports and army bases and their respective weather reports collected at approximately the same time are significantly different. In this case, only the weather reports from the mobile weather station 401 are suppressed, and not the reports from the nearby fixed weather station. This is because, in this embodiment, the weather quality platform 107 uses the weather data report from the trusted fixed weather station as ground truth data.

Returning to FIG. 1, as shown, the system 100 comprises one or more weather providers 101 operating respective sets of weather stations 103. As previously discussed the weather stations 103 can be fixed or mobile weather stations. For example, fixed weather stations 103 can be installed (e.g., permanently or semi-permanently) at locations selected to optimize weather data collection (e.g., a location where representative outside ambient measurements can be taken that minimizes factors that can affect weather data readings such as obstructions, direct exposure to sunlight, clear line of sight, etc.). In contrast, mobile weather stations 103 do not have fixed locations and can move along with a traveler and/or vehicle to which they are associated. As a result, the weather sampling locations for mobile weather stations 103 are highly variable.

In one embodiment, the weather stations 103 (e.g., either fixed or mobile) can be equipped with a range of weather sensors for sensing any number of weather attributes or parameters. For example, these sensors include, but are not limited to: (1) thermometer for measure air or surface temperatures, (2) barometer for measuring atmospheric pressure, (3) hygrometer for measuring humidity, (3) anemometer for measuring wind speed, (4) pyranometer for measuring solar radiation, (5) rain gauge for measuring liquid precipitation, (6) precipitation identification sensor for identifying type of falling precipitation, (7) disdrometer for measuring precipitation drop size distribution, (8) transmissometer for measuring visibility, (8) ceilometer for measuring cloud ceiling, and/or the like. It is contemplated that the weather stations 103 can be equipped with any type of weather or environmental sensor known in the art. In one embodiment, the weather stations 103 collect weather data (e.g., weather attribute values) that can be used to characterize current weather conditions and/or predict future weather conditions (e.g., weather forecasts).

In one embodiment, the weather stations 103 are equipped with logic, hardware, firmware, software, memory, etc. to collect and store weather data measurements for their respective weather sensors continuously, periodically, according to a schedule, on demand, etc. In one embodiment, the logic, hardware, firmware, memory, etc. can be configured to perform the all or a portion of the various functions associated detecting quality weather providers 101, weather stations 103, and/or weather reports according to the embodiment described herein. The weather stations 103 can also include means for transmitting the collected and stored weather data over, for instance, the communication network 105 to weather quality platform 107 and/or any other components of the system 100 for detecting quality weather providers 101, weather stations 103, and/or weather reports according to the embodiment described herein.

In one embodiment, mobile weather stations 103 can be associated with travelers and/or vehicles (e.g., connected and/or autonomous cars). These travelers and/or vehicles equipped with such mobile weather stations 104 can act as probes traveling over a road network within a geographical area represented in the geographic database 109. Although the vehicles are often described herein as automobiles, it is contemplated that the vehicles can be any type of vehicle, manned or unmanned (e.g., planes, aerial drone vehicles, motor cycles, boats, bicycles, etc.), and the mobile weather stations 103 can be associated with any of the types of vehicles or a person or thing (e.g., a pedestrian) traveling within the road or transportation network. In one embodiment, each weather station 103 is assigned a unique identifier (station ID) for use in reporting or transmitting weather data and/or related probe data (e.g., location data).

In one embodiment, the mobile weather stations 103 can be part of vehicles and/or other devices (e.g., mobile phones, portable navigation devices, etc.) that are part of a probe-based system for measuring weather and traffic conditions in a road network. In one embodiment, each weather station, vehicle, and/or device is configured to report weather data in addition to probe points. By way of example, probe points are individual data records collected at a point in time that records telemetry data for that point in time. As noted, the weather data and/or probe points can be reported from the weather stations, vehicles, and/or devices in real-time, in batches, continuously, or at any other frequency requested by the system 100 over, for instance, the communication network 105 for processing by the weather quality platform 107.

In one embodiment, the weather quality platform 107 can use probe data or probe point information to map match locations of weather reports received from mobile weather stations 103 to determine whether the reported weather data should be used or suppressed. By way of example, a probe point can include attributes such as: probe ID, longitude, latitude, speed, and/or time. The list of attributes is provided by way of illustration and not limitation. Accordingly, it is contemplated that any combination of these attributes or other attributes may be recorded as a probe point (e.g., such as those previously discussed above). For example, attributes such as altitude (e.g., for flight capable vehicles or for tracking non-flight vehicles in the altitude domain), tilt, steering angle, wiper activation, etc. can be included and reported for a probe point. In one embodiment, if the probe point data includes altitude information, the transportation network, links, etc. can also be paths through an airspace (e.g., to track aerial drones, planes, other aerial vehicles, etc.), or paths that follow the contours or heights of a road network (e.g., heights of different ramps, bridges, or other overlapping road features).

In one embodiment, the weather quality platform 107 performs the processes for detecting quality weather providers 101, weather stations 103, and/or weather reports as discussed with respect to the various embodiments described herein. By way of example, the weather quality platform 107 can be a standalone server or a component of another device with connectivity to the communication network 105. For example, the component can be part of an edge computing network where remote computing devices (not shown) are installed along or within proximity of a given geographical area to provide weather provider/weather station monitoring for weather data collected locally or within a local area served by the remote or edge computing device.

In one embodiment, a weather station can be any device equipped with one or more of the weather sensors discussed above. By way of example, such a device can be any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the device can support any type of interface to the user (such as “wearable” circuitry, etc.).

The communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the weather quality platform 107 may be a platform with multiple interconnected components. The weather quality platform 107 may include multiple servers, intelligent networking devices, computing devices, components and corresponding software for detecting quality weather providers 101, weather stations 103, and/or weather reports. In addition, it is noted that the weather quality platform 107 may be a separate entity of the system 100, a part of one or more services 111a-111j (collectively referred to as services 111) of the services platform 113, or included within the weather stations 103.

The services platform 113 may include any type of service 111. By way of example, the services 117 may include weather services, mapping services, navigation services, travel planning services, notification services, social networking services, content (e.g., audio, video, images, etc.) provisioning services, application services, storage services, contextual information determination services, location based services, news services, etc. In one embodiment, the services platform 113 may interact with the weather quality platform 107, the weather providers 101, the weather stations 103, and/or one or more content providers 115a-115k (also collectively referred to as content providers 115) to provide the services 117.

In one embodiment, the content providers 115 may provide content or data to the weather providers 101, the weather quality platform 107, and/or the services 111. The content provided may be any type of content, such as historical weather data for the weather stations 103, mapping content, textual content, audio content, video content, image content, etc. In one embodiment, the content providers 115 may provide content that may aid in the detecting quality weather providers 101, weather stations 103, and/or weather reports according to the various embodiments described herein. In one embodiment, the content providers 121 may also store content associated with the weather stations 103, the weather quality platform 107, and/or the services 117. In another embodiment, the content providers 115 may manage access to a central repository of data, and offer a consistent, standard interface to data, such as a repository of historical or current weather data, probe data, probe features/attributes, link features/attributes, etc.

By way of example, the weather providers 101, weather stations 103, weather quality platform 107, services platform 113, and/or the content providers 115 communicate with each other and other components of the system 100 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

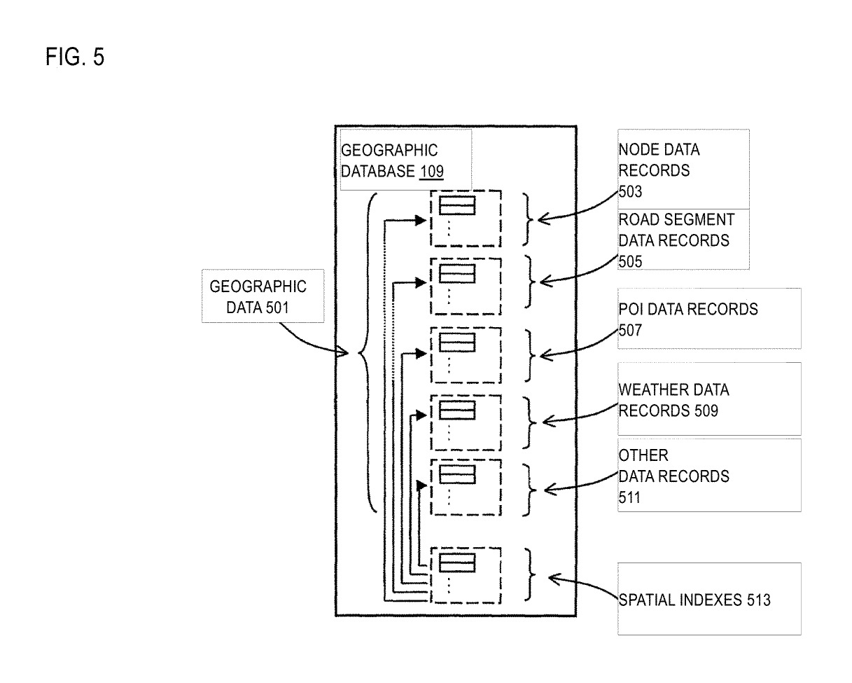

FIG. 5 is a diagram of the geographic database 109 of system 100, according to exemplary embodiments. In the exemplary embodiments, weather data generated by the weather stations 103 can be stored, associated with, and/or linked to the geographic database 109 or data thereof. In one embodiment, the geographic database 109 includes geographic data 501 used for (or configured to be compiled to be used for) mapping and/or navigation-related services, such as for personalized route determination, according to exemplary embodiments. For example, the geographic database 109 includes node data records 503, road segment or link data records 505, POI data records 507, weather data records 509, and other data records 511, for example. More, fewer or different data records can be provided. In one embodiment, the other data records 511 include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using the point-based map matching embodiments describes herein), for example.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three dimensional polygon extrusions, models, routes, etc. Accordingly, the terms polygons and polygon extrusions/models as used herein can be used interchangeably.

In one embodiment, the following terminology applies to the representation of geographic features in the geographic database 109.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 109 follows certain conventions. For example, links do not cross themselves and do not cross each other except at a node or vertex. Also, there are no duplicated shape points, nodes, or links. Two links that connect each other have a common node or vertex. In the geographic database 109, overlapping geographic features are represented by overlapping polygons. When polygons overlap, the boundary of one polygon crosses the boundary of the other polygon. In the geographic database 109, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In exemplary embodiments, the road segment data records 505 are links or segments representing roads, streets, or paths, as can be used in the calculated route or recorded route information for determination of one or more personalized routes, according to exemplary embodiments. The node data records 503 are end points or vertices corresponding to the respective links or segments of the road segment data records 505. The road link data records 505 and the node data records 503 represent a road network, such as used by vehicles, cars, and/or other entities. Alternatively, the geographic database 109 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 109 can include data about the POIs and their respective locations in the POI data records 507. The geographic database 109 can also include data about places, such as cities, towns, or other communities, and other geographic features, such as bodies of water, mountain ranges, etc. Such place or feature data can be part of the POI data records 507 or can be associated with POIs or POI data records 507 (such as a data point used for displaying or representing a position of a city).

In one embodiment, the geographic database 109 includes weather data records 509 which store weather data reports and/or related probe point data. For example, the weather data records 409 can store map matching results for individual weather reports. These results can indicate, for instance, a specific road or link on which the weather data was collected, a determined transportation mode, a presence of covered map features (e.g., a tunnel), nearby weather stations 103 available for performing station to station checks, etc.

The geographic database 109 can be maintained by the content provider 115 in association with the services platform 113 (e.g., a map developer). The map developer can collect geographic data to generate and enhance the geographic database 109. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 109 can be a master geographic database stored in a format that facilitates updating, maintenance, and development. For example, the master geographic database 109 or data in the master geographic database 109 can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

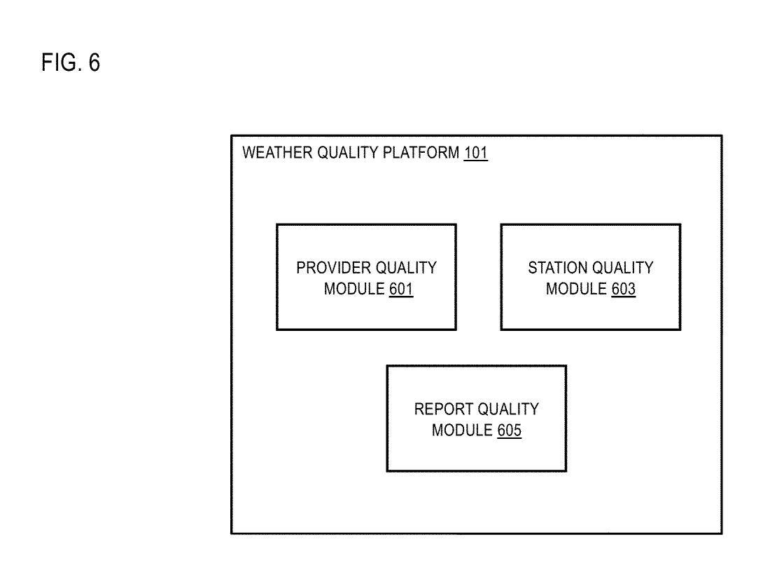

FIG. 6 is a diagram of the components of a weather quality platform 107, according to one embodiment. By way of example, the weather quality platform 107 includes one or more components for detecting quality weather providers 101, weather stations 103, and/or weather reports according to the various embodiments described herein. It is contemplated that the functions of these components may be combined or performed by other components of equivalent functionality. In this embodiment, the weather quality platform 107 includes a provider quality module 601, a station quality module 603, and a report quality module 605. The above presented modules and components of the weather quality platform 107 can be implemented in hardware, firmware, software, or a combination thereof. Though depicted as a separate entity in FIG. 1, it is contemplated that the weather quality platform 107 may be implemented as a module of any of the components of the system 100 (e.g., a component of the services platform 113, the weather stations 103, the weather providers 101, etc.). In another embodiment, one or more of the modules 601-605 may be implemented as a cloud based service, local service, native application, or combination thereof.

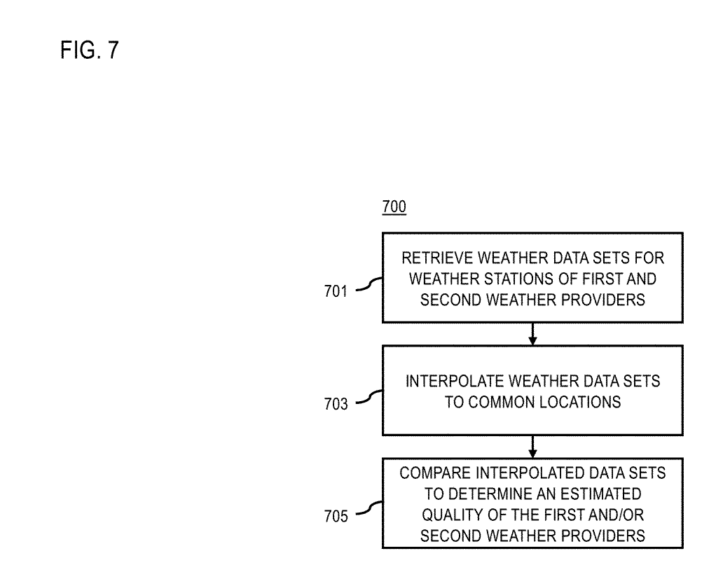

The functions of these modules are discussed with respect to FIGS. 7, 8A-8B, and 9 below. In one embodiment, the processes of FIGS. 7, 8A-8B, and 9 can be performed in combination as part of an overall weather quality pipeline for detecting and/or remediating weather providers 101, weather stations 103, and/or weather reports determined to be erroneous or faulty. In addition or alternatively, any of the processes can FIGS. 7, 8A-8B, and 9 can be performed independently to provide separate detection of erroneous weather providers 101, erroneous weather stations 103, and/or weather reports to suppress.

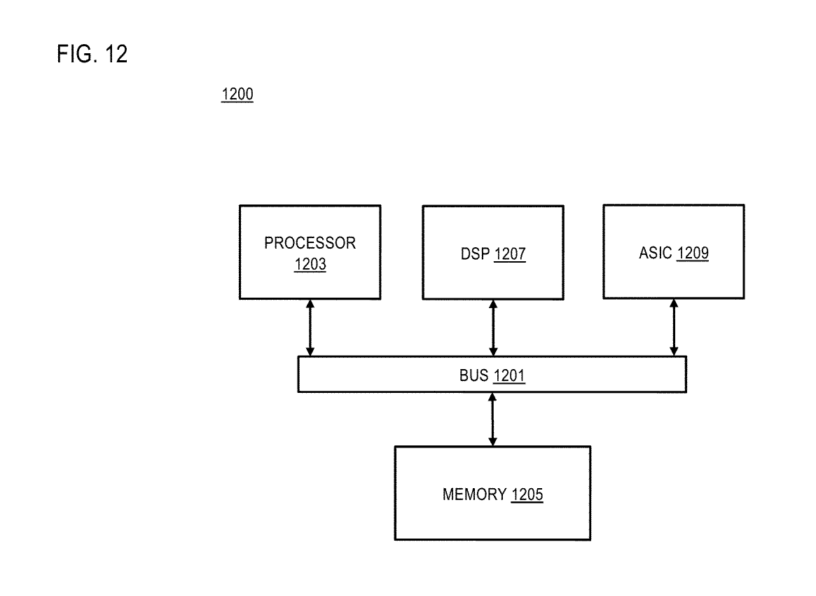

FIG. 7 is a flowchart of a process for determining an erroneous weather provider, according to one embodiment. In various embodiments, the weather quality platform 107 and/or any of the modules 601-605 of the weather quality platform 107 as shown in FIG. 6 may perform one or more portions of the process 700 and may be implemented in, for instance, a chip set including a processor and a memory as shown in FIG. 12. As such, the weather quality platform 107 and/or the modules 601-605 can provide means for accomplishing various parts of the process 700, as well as means for accomplishing embodiments of other processes described herein in conjunction with other components of the system 100. Although the process 700 is illustrated and described as a sequence of steps, its contemplated that various embodiments of the process 700 may be performed in any order or combination and need not include all of the illustrated steps.

In step 701, the provider quality module 601 retrieves a first set of weather data reported from a first set of weather stations of a first weather data provider. In one embodiment, the first set of weather stations located in a selected geographical area. For example, the selected geographical area of interest can be selected so that a minimum number of weather stations are located within the geographical area. The provider quality module 601 also retrieves a second set of weather data reported from a second set of weather stations of a second weather data provider, the second set of weather stations located in the selected geographical area. The weather data can include all available weather attributes reported by the weather stations or may include only one or more weather attributes or parameters that are selected for comparison. As previously noted, the provider quality module 601 can make quality assessments independent for each weather attribute. For example, the provider quality module 601 may chose compare air temperature first and then atmospheric pressure. In this way, a provider may be designated as erroneous with respect to one attribute, but may nonetheless be not erroneous with respect to another attribute.

In one embodiment, the provider quality module 601 also determines the respective locations of the first and second sets of weather stations. The locations can be determined, for instance, from location data associated with the reports originating from the respective weather stations. In addition or alternatively, the locations can determined from mapping data provided by the respective weather providers. Typically, the locations of first and second sets of weather stations are not the same because it is unlikely that different providers will install their weather stations at the same locations as another provider. In addition, if any of the weather stations are mobile, their respective locations are inherently variable. This location difference or variability makes it difficult to directly compare two different weather providers because even relatively small differences in weather data sampling locations can be result in significant differences in the associated weather attribute values. As the distance between weather stations grows, the differences tend to become even more significant.

To address this issue, the provider quality module 601 can interpolate available weather data from each weather provider to determine respective values at designated common comparison locations. For example, in step 703, the provider quality module 601 interpolates the first set of weather data to determine a first interpolated weather data set at one or more common comparison locations. The provider quality module 601 also interpolates the second set of the weather data to determine a second interpolated weather data set at the one or more common comparison locations. In other words, for each provider weather data set, the provider quality module 601 can use any known weather interpolation algorithm to calculate an estimated or interpolated value for a target location (e.g., each common comparison point) given the locations and sensed weather attribute values for nearby weather stations as an input into that algorithm. The interpolated value would then represent an estimated weather attribute value that would have been sensed if a weather station were located at that comparison point. As noted above, in one embodiment, the provider quality module 601 can select at least one test weather attribute (e.g., air temperature) for evaluation. Then the first interpolated weather data set and the second interpolated weather data set are generated based on the selected at least one test weather attribute.

In one embodiment, the provider quality module 601 can select any number or arrangement of the common comparison points. For example, in one embodiment, the provider quality module 601 can divide the selected geographical area into a grid. The one or more comparison locations are then selected according to the grid, e.g., by designating a grid point location in each cell as the one or more common comparison locations. The center point or any other point of the grid cell can be selected as the one or more common comparison location.

After the interpolation of each weather data set, the provider quality module 601 then has one interpolated weather attribute value for each of the weather providers being compared. Accordingly, in step 705, the provider quality module 601 compares the first interpolated weather data set and the second interpolated weather data set at the one or more common comparison locations to determine an estimated quality of the first weather data provider, the second weather data provider, or combination thereof.

To make this comparison, in one embodiment, the provider quality module 601 can determine a ground truth weather data set for the one or more common locations. The ground truth weather data set is, for instance, a set of weather attribute values for each of the one or more comparison locations that the provider quality module 601 will consider to be the true weather attribute value at the given comparison location. As discussed above, the ground truth weather data can be selected from either of the first or second weather data sets being compared. For example, if either the first or second providers is a previously trusted provider (e.g., a governmental provider operating fixed high quality weather stations), then that provider can be designated as the ground truth provider. Alternatively, the provider quality module 601 can select a third provider as the ground truth against which the first and provider providers are to be compared. In this case, the provider quality module 601 can also interpolate the weather from this third party ground truth provider to estimate ground truth weather attribute values at each of the one or more common comparison points.

In one embodiment, the comparing of the first interpolated weather data set and the at least one second interpolated weather data set then comprises comparing the first interpolated weather data set, the at least one second interpolated weather data set, or a combination thereof to the ground truth weather data at the one or more common comparison locations. For example, in one embodiment, the provider quality module 601 computes an average difference between the ground truth weather data set and the first interpolated weather data set or the second interpolated weather data set at each common comparison location. The provider quality module 601 then designates the first interpolated weather data set or the second interpolated weather data set as erroneous when the average difference across all common comparison locations is greater than a threshold value.

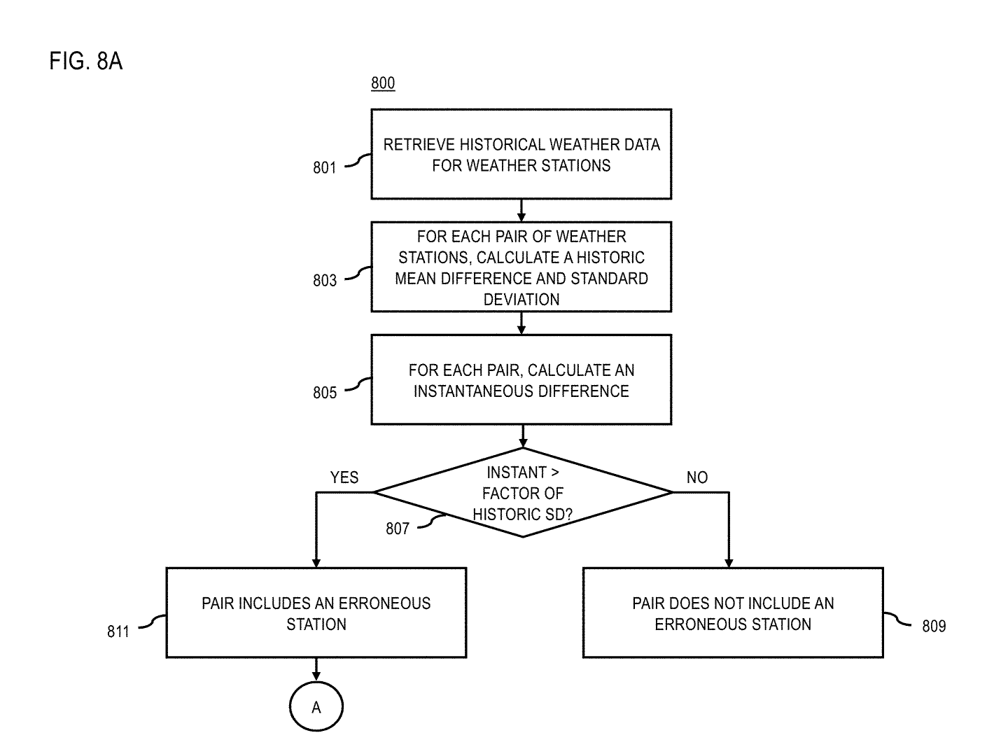

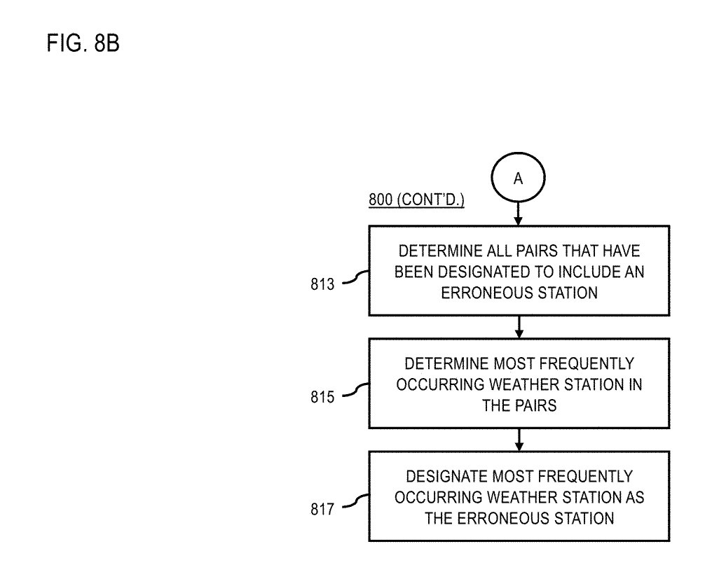

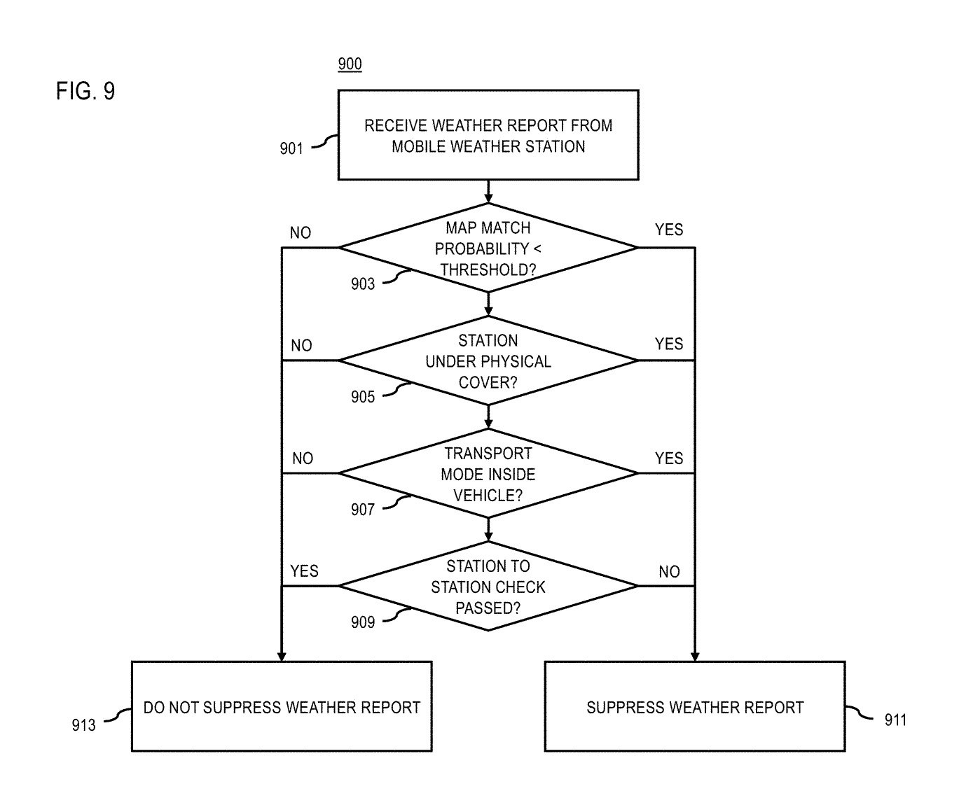

FIGS. 8A and 8B are a flowchart of a process for determining an erroneous weather station, according to one embodiment. FIGS. 8A and 8B depict a single process 800 is continued from FIG. 8A at step 811 to FIG. 8B at step 813. In various embodiments, the weather quality platform 107 and/or any of the modules 601-605 of the weather quality platform 107 as shown in FIG. 6 may perform one or more portions of the process 800 and may be implemented in, for instance, a chip set including a processor and a memory as shown in FIG. 12. As such, the weather quality platform 107 and/or the modules 601-605 can provide means for accomplishing various parts of the process 800, as well as means for accomplishing embodiments of other processes described herein in conjunction with other components of the system 100. Although the process 800 is illustrated and described as a sequence of steps, its contemplated that various embodiments of the process 800 may be performed in any order or combination and need not include all of the illustrated steps. In one embodiment, it is contemplated that the process 800 can be performed in combination with any of the processes of FIG. 7 above or the FIG. 9 below, or can be performed as a standalone process.

In step 801, the station quality module 603 retrieves historical weather data for a first set of weather stations. In one embodiment, the station quality module 603 can select a period of time in the past that the historical weather data covers so that seasonal or other differences can be accounted for. For example, in one embodiment, the historical weather data covers at least one year to ensure that historical data from all four seasons are represented.

In one embodiment, the station quality module 603 then identifies all possible pairs of the weather stations in the retrieved set of weather stations and creates an all-pairs list. As previously noted, in one embodiment, the all-pairs list does not include combinations of the same weather station. In this embodiment, the all-pairs list also is not order specific so that pairs that differ only in order of the weather stations (e.g., (WS1,WS2) and (WS2,W1)) are considered to be equivalent and are included only once in the all-pairs list. In one embodiment, the weather stations are determined as a subset of weather stations in this first set that are within a predetermined radius from a selected location (e.g., a location of a weather station of interest). Accordingly, in this embodiment, the pair would be constructed from only those weather stations physically located within the predetermined radius or area.

In step 803, the station quality module 603 calculates a historical mean difference of a selected weather attribute and a historical standard deviation from the mean difference for each pair of weather stations in the first set of weather stations (e.g., each pair in the all-pairs list). In other words, for all pairs of weather attribute values sensed at the same time for a given pair of weather station, the station quality module 603 calculates a difference value. The difference values for all pairs are averaged to determine the mean, and then a standard deviation of each difference from this mean is determined. In one embodiment, the mean difference and standard deviation from the mean difference is recorded in a table indexed for each pair of weather stations in the selected geographical region.

For said each pair of weather stations, the station quality module 603 calculates an instantaneous difference in the selected weather attribute from the first set of weather data (step 805). For example, this first set of weather data represents real time weather data currently being collected from the weather stations in the selected geographical area. In this example, instantaneous difference between any pair of stations refers to a difference in weather attribute values (e.g., for a selected weather attribute of interest) determined from real-time weather data as opposed to the historical weather data used in the step above.

In step 805, the station quality module 603 determines whether the instantaneous difference calculated for each pair is greater than the historical standard deviation for the respective pair by greater than a predetermined factor (e.g., three times the standard deviation). To make this determination, the station quality module 603 can query the table of historical mean difference and standard deviation to retrieve the historical standard deviation from the mean difference for the target pair. In one embodiment, the station quality module 603 can vary the threshold factor to apply to the historical standard deviation based on a desired level of confidence that an observed difference is significant (e.g., a higher factor leading to greater confidence, and a lower factor leading lower confidence).

In step 809, the station quality module 603 determines that the pair does not include an erroneous weather station if the instantaneous difference is not greater than the historical standard deviation by a predetermined. Otherwise, the station quality module 603 designates at least one weather station in said each pair of weather stations as an erroneous weather station when the instantaneous difference is greater than the historical standard deviation by a predetermined factor (step 811).

In one embodiment, to determine which station of the pair is erroneous, the station quality module 603 determines or identifies all pairs of weather stations that are designated as having at least one erroneous weather station (step 813). In step 815, the station quality module 603 then determines a most frequently occurring weather station in all of the pairs that are designated with an erroneous weather station. The most frequently occurring weather station can then be designated as the erroneous weather station (step 817).

FIG. 9 is a flowchart of a process for determining an erroneous weather report, according to one embodiment. In various embodiments, the weather quality platform 107 and/or any of the modules 601-605 of the weather quality platform 107 as shown in FIG. 6 may perform one or more portions of the process 900 and may be implemented in, for instance, a chip set including a processor and a memory as shown in FIG. 12. As such, the weather quality platform 107 and/or the modules 601-605 can provide means for accomplishing various parts of the process 900, as well as means for accomplishing embodiments of other processes described herein in conjunction with other components of the system 100. Although the process 900 is illustrated and described as a sequence of steps, its contemplated that various embodiments of the process 900 may be performed in any order or combination and need not include all of the illustrated steps. In one embodiment, it is contemplated that the process 900 can be performed in combination with any of the processes of FIG. 7 or FIGS. 8A and 8B above, or can be performed as a standalone process.

In step 901, the report quality module 605 receives a weather report record (e.g., weather data) from a mobile weather station or otherwise determines that the weather report record originates from a mobile weather station. Because weather data can be highly dependent on location, mobile weather stations present particular technical challenges to ensuring quality weather data (e.g., weather data that accurately represents outside ambient weather conditions). This is because unlike fixed weather stations whose locations are carefully selected to result in high quality weather data, mobile weather stations can potentially be located anywhere within a geographical including locations that may not be conducive to generating quality weather data or reports (e.g., indoors, near obstructions, etc.). To the address this potential problem, the report quality module 605 can employ one or more of the steps described below alone or in combination to determine whether or not to use a given weather report or data collected from a mobile weather station.

In step 903, the report quality module 605 calculates a probability that a location where the mobile weather station generated the weather report record is mapped to a road network in the selected geographical area from which the weather report is received. The report quality module 605 then determines whether the calculated map matching probability is less than a predetermined threshold. When the matching probability is less than the predetermined threshold, the report quality module 605 suppresses the weather report record or otherwise removes the weather report record from the system 100 (step 911). When the matching probability is not less than the predetermined threshold, the weather report record is not suppressed (step 913). As discussed above, the report quality module 605 can be configured to assume that reports generated by a mobile weather station that is not on a road network indicates that the mobile weather station is likely to be indoors. For example, if a mobile weather station is a connected car with weather sensing capabilities is not on a road, the car is likely to be in a parked location which is often indoors. On the contrary if the car is on a road, it is either traveling or parked in a road way, indicating that the vehicle is likely to be exposed to an open environment where it can obtain weather data representative of ambient outdoor weather conditions.

In step 905, the report quality module 605 determines whether the location where the mobile weather station generated the received weather report is mapped to a portion of the road network (e.g., a road segment) that includes a map feature with physical cover from an environment of the selected geographical area (e.g., a tunnel, lower deck of a double deck highway, etc.). When mapped to such a feature, the report quality module 605 suppresses the weather report (step 911). Otherwise, the report is not suppressed (step 913). In some cases, even if a mobile weather station is mapped to a road as described above, the portion of the road on which the station is mapped can nonetheless not be conducive to generating representative weather data. For example, if the vehicle is on the road but traveling in a tunnel or other covered or isolated map feature, the weather conditions within the tunnel or feature may not be representative of general ambient outdoor weather conditions.

In step 907, the report quality module 605 determines a transportation mode associated with the mobile weather station at the time the weather report was generated. In one embodiment, the report quality module 605 then determines whether the transportation mode indicates a likelihood that the at least one mobile weather station is located inside of a vehicle (e.g., when traveling by car, bus, train, or other similar vehicle). When the transportation mode indicates such a likelihood, the report quality module 605 suppresses the weather report (step 911). Otherwise, the report is not suppressed (step 913). For example, using a transportation mode that indicates a mobile weather station is likely to be location inside a vehicle also means that the corresponding weather data generated by the mobile weather station also is likely to be representative of the inside environment of the vehicle and not general ambient outdoor weather conditions (e.g., the outdoor conditions characteristic of high quality data as configured for the system 100).

In step 909, the report quality module 605 can perform a station to station check of a weather report record from a given mobile weather station. For example, in one embodiment, the report quality module 605 can obtain weather data from other weather stations (e.g., mobile or fixed) within a threshold distance of the mobile weather station that generated the initial report. The report quality module 605 then determines whether the weather report or data generated by the given mobile weather station differs (e.g., beyond a threshold value such as a multiple of a standard deviation difference) from the weather reports received from at least one neighboring weather station. In one embodiment, the station to station check is passed when the reports differ less than the threshold value, and is not passed when the reports differ more than the threshold value. Accordingly, the report quality module 605 suppresses the weather report (step 911) when the station to station check is not passed. In one embodiment, reports from both the given mobile weather and the neighboring weather station are suppressed. Otherwise, the report is not suppressed (step 913).

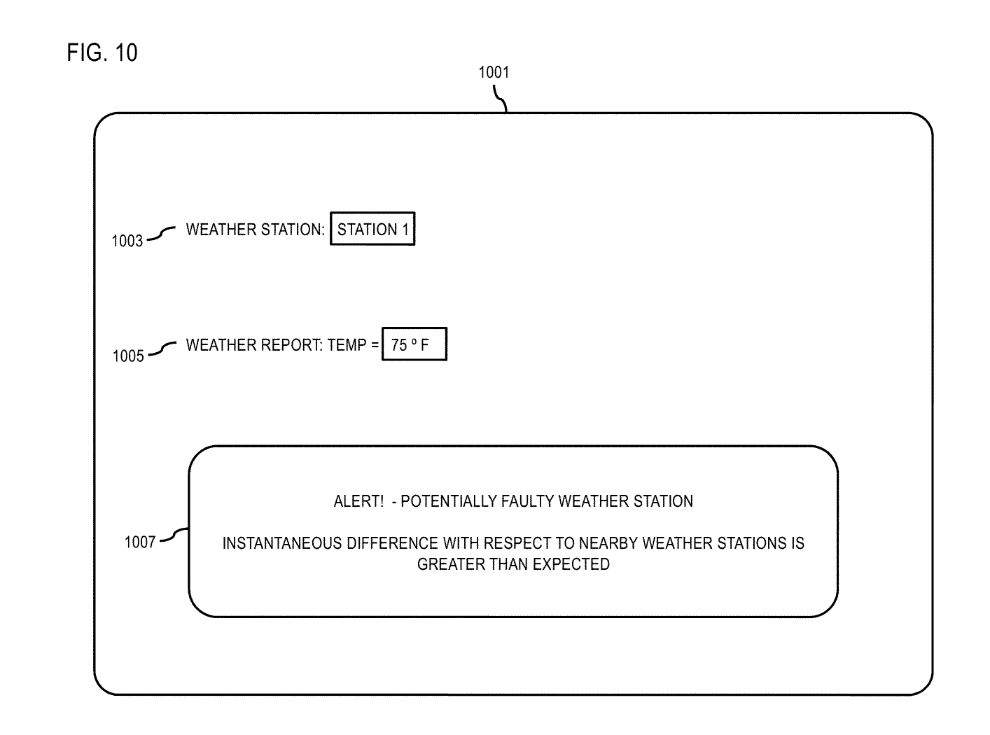

FIG. 10 is a diagram illustrating an example user interface for detecting an erroneous weather station, according to one embodiment. In the example of FIG. 10, a user interface (UI) 1001 enables a user to select a weather station at user interface element 1003 (e.g., Station 1). On making a selection, the UI 1003 presents a user interface element 1005 displaying the real-time value (e.g., 75° F.) for an air temperature attribute measured by the selected Station 1.

At the same, the weather quality platform 107 can initiate a quality check of Station 1 by calculating instantaneous differences of the air temperature reported by Station 1 against temperatures reported by neighboring weather stations (e.g., Station 2 and Station 3, not shown). In this example, Station 2 and Station 3 each report a real-time temperature of 65° F., resulting in an instantaneous difference of 10° F. for between Station 1 and Station 2, and between Station 1 and Station 3. The weather quality platform 107 then retrieves historical standard deviations of differences in temperature readings between Station 1 and Station 2 (e.g., a historical standard deviation of 2.5° F.) and between Station 1 and Station 3 (e.g., a historical standard device of 3° F.).

In one embodiment, a threshold value for comparing the instantaneous difference between each pair of stations can then be calculated by applying a predetermined factor (e.g., 3) to the retrieved historical standard deviations to results in a 7.5° F. threshold for Station 1-Station 2 pair, and a 9° F. for the Station 1-Station 3 pair. The weather quality platform 107 can then compare the computed instantaneous differences for each pair against the respective threshold values. In this example, for both the Station 1-Station 2 pair and the Station 1-Station 3 pair, the respective thresholds are exceeded, indicating that each pair includes a potentially erroneous weather station. Because Station 1 appears in both pairs, the weather quality platform 107 can determine that Station 1 is potentially erroneous or faulty. In response, the UI 1001 can display an alert message 1007 to indicate that the selected Station 1 is potentially faulty or erroneous.

The processes described herein for detecting a quality weather provider, weather station, or weather report may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

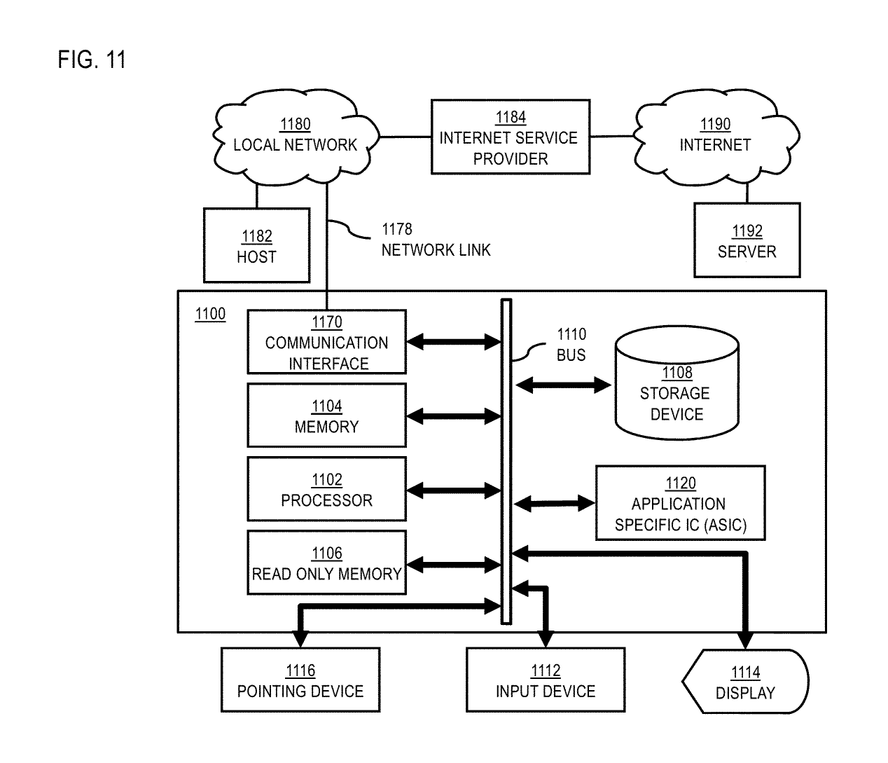

FIG. 11 illustrates a computer system 1100 upon which an embodiment of the invention may be implemented. Computer system 1100 is programmed (e.g., via computer program code or instructions) to detect a quality weather provider, weather station, or weather report as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to detecting a quality weather provider, weather station, or weather report. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or other dynamic storage device, stores information including processor instructions for detecting a quality weather provider, weather station, or weather report. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for detecting a quality weather provider, weather station, or weather report, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver. In certain embodiments, the communications interface 1170 enables connection to the communication network 105 for detecting a quality weather provider, weather station, or weather report.

The term computer-readable medium is used herein to refer to any medium that participates in providing information to processor 1102, including instructions for execution. Such a medium may take many forms, including, but not limited to, non-volatile media, volatile media and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 12 illustrates a chip set 1200 upon which an embodiment of the invention may be implemented. Chip set 1200 is programmed to detect a quality weather provider, weather station, or weather report as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to detect a quality weather provider, weather station, or weather report. The memory 1205 also stores the data associated with or generated by the execution of the inventive steps.

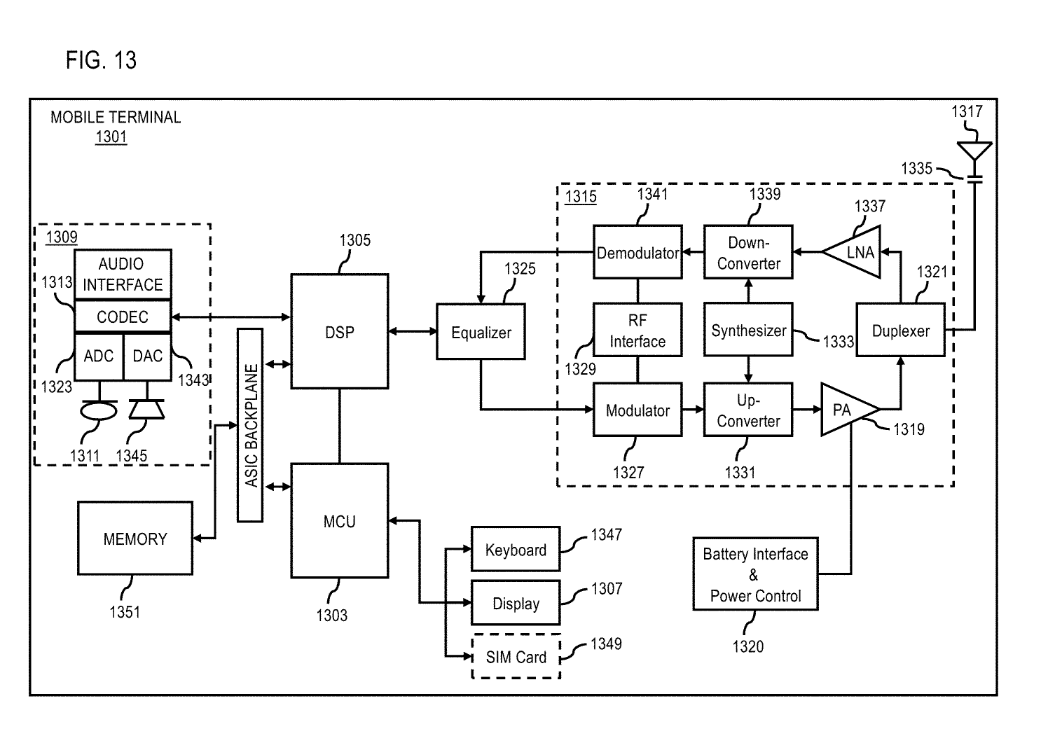

FIG. 13 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile station functions that offer automatic contact matching. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile station 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303—which can be implemented as a Central Processing Unit (CPU) (not shown).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile station 1301 to detect a quality weather provider, weather station, or weather report. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the station. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile station 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1351 may be, but not limited to, a single memory, CD, DVD, ROM, RAM, EEPROM, optical storage, or any other non-volatile or non-transitory storage medium capable of storing digital data.

An optionally incorporated SIM card 1349 carries, for instance, important information, such as the cellular phone number, the carrier supplying service, subscription details, and security information. The SIM card 1349 serves primarily to identify the mobile station 1301 on a radio network. The card 1349 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
retrieving a first set of weather data reported from a first set of weather stations of a first weather data provider, the first set of weather stations located in a selected geographical area;
retrieving a second set of weather data reported from a second set of weather stations of a second weather data provider, the second set of weather stations located in the selected geographical area;
interpolating the first set of weather data to determine a first interpolated weather data set at one or more common comparison locations;
interpolating the second set of the weather data to determine a second interpolated weather data set at the one or more common comparison locations;
comparing the first interpolated weather data set and the second interpolated weather data set at the one or more common comparison locations to determine an estimated quality of the first weather data provider, the second weather data provider, or combination thereof.

2. The method of claim 1, further comprising:
dividing the selected geographical area into a grid; and
selecting the one or more common comparison locations according to the grid.

3. The method of claim 2, further comprising:
determining a ground truth weather data set for the one or more common locations, wherein the comparing of the first interpolated weather data set and the at least one second interpolated weather data set comprises comparing the first interpolated weather data set, the at least one second interpolated weather data set, or a combination thereof to the ground truth weather data.

4. The method of claim 3, further comprising:
computing an average difference between the ground truth weather data set and the first interpolated weather data set or the second interpolated weather data set; and
designating the first interpolated weather data set or the second interpolated weather data set as erroneous when the average difference is greater than a threshold value.

5. The method of claim 3, further comprising:
designating the first interpolated weather data set or the second interpolated weather data set as the ground truth weather data set.

6. The method of claim 1, further comprising:
selecting at least one test weather attribute,
wherein the first interpolated weather data set and the second interpolated weather data set are generated based on the selected at least one test weather attribute.

7. The method of claim 1, further comprising:
retrieving historical weather data for the first set of weather stations;
for each pair of weather stations in the first set of weather stations, calculating a historical mean difference of a selected weather attribute and a historical standard deviation from the mean difference;
for said each pair of weather stations, calculating an instantaneous difference of the selected weather attribute from the first set of weather data; and
designating at least one weather station in said each pair of weather stations as an erroneous weather station when the instantaneous difference is greater than the historical standard deviation by a predetermined factor.

8. The method of claim 7, further comprising:
determining all pairs of said each pair of weather stations that are designated as having at least one erroneous weather station;
determining a most frequently occurring weather station in the determined all pairs; and
designating the most frequently occurring weather station as the erroneous weather station.

9. The method of claim 7, further comprising:
determining a subset of the first set of weather stations that are within a predetermined radius,
wherein said each pair of weather stations is constructed from the subset.

10. The method of claim 1, wherein the first set of weather stations include at least one mobile weather station, the method further comprising:
calculating a probability that the at least one mobile weather station is mapped to a road network in the selected geographical area; and
suppressing weather data from the at least one mobile weather station when the probability is less than a predetermined threshold.

11. The method of claim 1, wherein the first set of weather stations include at least one mobile weather station, the method further comprising:
determining a transportation mode associated with the at least one mobile weather station; and
suppressing weather data from the at least one mobile weather station when the transportation mode indicates a likelihood that the at least one mobile weather station is located inside of a vehicle.

12. The method of claim 1, wherein the first set of weather stations include at least one mobile weather station, the method further comprising:
suppressing weather data from the at least one mobile weather station when the at least one mobile weather station is map matched to a road segment that includes a map feature with physical cover from an environment of the selected geographical area,
wherein the map feature includes at least a tunnel.

13. The method of claim 1, wherein the first set of weather stations include at least one mobile weather station, the method further comprising:
suppressing weather data from the at least one mobile weather station when the weather data differs from other weather data collected from at least one other weather station that is within a threshold distance of the at least one mobile weather station,
wherein the at least one other weather station is a fixed weather station or a mobile weather station.

14. An apparatus comprising:
at least one processor; and
at least one memory including computer program code for one or more programs,
the at least one memory and the computer program code configured to, with the at least one processor, cause the apparatus to perform at least the following,
retrieve a first set of weather data reported from a first set of weather stations of a first weather data provider, the first set of weather stations located in a selected geographical area;
retrieve a second set of weather data reported from a second set of weather stations of a second weather data provider, the second set of weather stations located in the selected geographical area;
interpolate the first set of weather data to determine a first interpolated weather data set at one or more common comparison locations;
interpolate the second set of the weather data to determine a second interpolated weather data set at the one or more common comparison locations;
compare the first interpolated weather data set and the second interpolated weather data set at the one or more common comparison locations to determine an estimated quality of the first weather data provider, the second weather data provider, or combination thereof.

15. The apparatus of claim 14, wherein the apparatus is further caused to:
determine a ground truth weather data set for the one or more common locations;
compute an average difference between the ground truth weather data set and the first interpolated weather data set or the second interpolated weather data set; and
designate the first interpolated weather data set or the second interpolated weather data set as erroneous when the average difference is greater than a threshold value.

16. The apparatus of claim 14, wherein the apparatus is further caused to:
retrieve historical weather data for the first set of weather stations;
for each pair of weather stations in the first set of weather stations, calculate a historical mean difference of a selected weather attribute and a historical standard deviation from the mean difference;
for said each pair of weather stations, calculate an instantaneous difference of the selected weather attribute from the first set of weather data; and
designate at least one weather station in said each pair of weather stations as an erroneous weather station when the instantaneous difference is greater than the historical standard deviation by a predetermined factor.

17. The apparatus of claim 10, wherein the first set of weather stations include at least one mobile weather station, and wherein the apparatus is further caused to:
calculate a probability that the at least one mobile weather station is mapped to a road network in the selected geographical area; and
suppress weather data from the at least one mobile weather station when the probability is less than a predetermined threshold.

18. A non-transitory computer-readable storage medium carrying one or more sequences of one or more instructions which, when executed by one or more processors, cause an apparatus to at least perform the following steps:
retrieving a first set of weather data reported from a first set of weather stations of a first weather data provider, the first set of weather stations located in a selected geographical area;
retrieving a second set of weather data reported from a second set of weather stations of a second weather data provider, the second set of weather stations located in the selected geographical area;
interpolating the first set of weather data to determine a first interpolated weather data set at one or more common comparison locations;
interpolating the second set of the weather data to determine a second interpolated weather data set at the one or more common comparison locations;
comparing the first interpolated weather data set and the second interpolated weather data set at the one or more common comparison locations to determine an estimated quality of the first weather data provider, the second weather data provider, or combination thereof.

19. The non-transitory computer-readable storage medium of claim 18, wherein the apparatus is further caused to perform:
retrieving historical weather data for the first set of weather stations;
for each pair of weather stations in the first set of weather stations, calculating a historical mean difference of a selected weather attribute and a historical standard deviation from the mean difference;
for said each pair of weather stations, calculating an instantaneous difference of the selected weather attribute from the first set of weather data; and
designating at least one weather station in said each pair of weather stations as an erroneous weather station when the instantaneous difference is greater than the historical standard deviation by a predetermined factor.

20. The non-transitory computer-readable storage medium of claim 18, wherein the first set of weather stations include at least one mobile weather station, and wherein the apparatus is further caused to perform:
calculating a probability that the at least one mobile weather station is mapped to a road network in the selected geographical area; and
suppressing weather data from the at least one mobile weather station when the probability is less than a predetermined threshold.
